(19) United States
(12) Patent Application Publication
(10) Pub. No.: US 2026/0155687 A1
(43) Pub. Date: Jun. 4, 2026

(54) ROTOR, MOTOR, ELECTRIC DRIVE UNIT AND VEHICLE

(71) Applicant: Valeo eAutomotive Germany GmbH, Erlangen (DE)

(72) Inventors: Wenwu LI, Erlangen (DE); Wendi REN, Erlangen (DE); Anbang XIAO, Erlangen (DE); Jin XU, Erlangen (DE)

(73) Assignee: Valeo eAutomotive Germany GmbH, Erlangen (DE)

(21) Appl. No.: 19/405,963

(22) Filed: Dec. 2, 2025

(30) Foreign Application Priority Data
Dec. 2, 2024 (CN) 202411755374.4

(51) Int. Cl. H02K 1/27

(52) U.S. Cl. CPC H02K 1/27

(57) ABSTRACT

A rotor for a motor includes multiple rotor segments arranged side by side in an axial direction parallel to a centre axis of the motor rotor, each of the rotor segments having one or more magnetic pole arranged in a circumferential direction around the centre axis. The motor rotor includes one or more V-shaped rotor segment set, the V-shaped rotor segment set being formed of three consecutive rotor segments, the magnetic pole of a middle rotor segment of the V-shaped rotor segment set being twisted by an angle θ in a twisting direction relative to a zero point angular position of the motor rotor.

### TECHNICAL FIELD

The present disclosure relates to a rotor of a motor. The present disclosure further relates to a motor comprising such a rotor of a motor, an electric drive unit comprising the motor, and a vehicle comprising the electric drive unit.

### BACKGROUND

A rotor and a stator of a motor both have a tooth slot structure. Windings of the stator are accommodated in stator slots, and alternating current flowing therein gives rise to a rotating magnetic field, while magnets (e.g. permanent magnets) of the rotor are accommodated in slots or holes of the rotor, giving rise to circumferentially distributed magnetic poles, and generating torque for driving the rotor to rotate under the action of the rotating magnetic field of the stator. Since the rotor magnetic poles and the stator slots are limited in number, the torque experienced by the rotor during rotation is not constant; it will fluctuate. This torque fluctuation will result in the motor itself generating vibration and noise. In particular, in the case of a motor-driven vehicle, motor torque fluctuation will cause noise, vibration and harshness (NVH) problems for the vehicle as a whole.

In an existing motor, the rotor is typically divided into multiple segments. These segments can twist through a predetermined angle relative to each other, such that the magnetic poles of the rotor are tilted. As a result of this tilting, the torque fluctuations experienced by different segments of the rotor are no longer synchronous, but staggered in time or phase. Thus, the torque fluctuations of different segments can partially cancel each other out, reducing the total torque fluctuation of the rotor as a whole. Existing methods of twisting rotor segments include: sequentially twisting different segments of the rotor in the same circumferential direction; and not twisting two segments located at the centre of the rotor relative to one another, but sequentially twisting segments at two sides in different circumferential directions respectively relative to the two central segments.

However, existing methods of twisting rotors still struggle to meet the ever-increasing requirements regarding NVH in vehicles. Thus, there is an urgent need for a novel method of twisting rotor segments, which fully suppresses motor torque fluctuation, and improves vehicle NVH performance.

### SUMMARY

Thus, the present disclosure is intended to solve the abovementioned problem, having the objective of providing a rotor of a motor, a motor comprising such a rotor, an electric drive unit comprising such a motor, and a vehicle comprising such an electric drive unit. The rotor according to the present disclosure has a novel method of twisting rotor segments, being able to fully suppress motor torque fluctuation, reducing vibration and noise generated by torque fluctuation, and thus improving vehicle NVH performance.

The abovementioned objective is achieved through a rotor according to an embodiment of the present disclosure; the rotor comprises multiple rotor segments arranged side by side in an axial direction parallel to a centre axis of the rotor, each of the rotor segments having one or more magnetic pole arranged in a circumferential direction around the centre axis. The rotor comprises one or more V-shaped rotor segment set, the V-shaped rotor segment set being formed of three consecutive rotor segments, the magnetic pole of a middle rotor segment of the V-shaped rotor segment set being twisted by an angle θ in a twisting direction relative to a zero point angular position of the rotor, and the magnetic poles of two end rotor segments of the V-shaped rotor segment set being twisted by an angle θ in a twisting direction opposite to that of the middle rotor segment relative to the zero point angular position.

One objective of the present disclosure is to provide a rotor, which has a novel method of twisting rotor segments, and is able to fully suppress motor torque fluctuation, reducing vibration and noise generated by torque fluctuation. The rotor according to the present disclosure comprises a V-shaped rotor segment set having three rotor segments, among which, the middle rotor segment and each end rotor segment are twisted by the same twisting angle θ in opposite directions relative to the zero point angular position of the rotor. The inventors of the present disclosure found through simulation and experimental measurement that, compared with a motor whose rotor is twisted by an existing twisting method, the rotor according to the present disclosure can, through the use of such a V-shaped rotor segment set, significantly reduce the noise produced during motor operation. In particular, noise associated with the tooth slot structure can be reduced by about 5 decibels.

The rotor according to the present disclosure may also have one or more of the following features, alone or in combination.

According to an embodiment of the present disclosure, the rotor at least comprises a first V-shaped rotor segment set and a second V-shaped rotor segment set.

According to an embodiment of the present disclosure, the first V-shaped rotor segment set and the second V-shaped rotor segment set do not comprise a shared rotor segment.

According to an embodiment of the present disclosure, the magnetic poles of the middle rotor segments of the first V-shaped rotor segment set and the second V-shaped rotor segment set are twisted in the same twisting direction relative to the zero point angular position.

According to an embodiment of the present disclosure, the magnetic poles of the middle rotor segments of the first V-shaped rotor segment set and the second V-shaped rotor segment set are twisted in different twisting directions relative to the zero point angular position (z).

According to an embodiment of the present disclosure, the first V-shaped rotor segment set and the second V-shaped rotor segment set share two rotor segments, such that the middle rotor segment of the first V-shaped rotor segment set forms one end rotor segment of the second V-shaped rotor segment set, and one end rotor segment of the first V-shaped rotor segment set forms the middle rotor segment of the second V-shaped rotor segment set.

According to an embodiment of the present disclosure, the first V-shaped rotor segment set and the second V-shaped rotor segment set share one end rotor segment.

According to an embodiment of the present disclosure, the rotor further comprises a separate rotor segment which is adjacent to one end rotor segment of one V-shaped rotor segment set but does not belong to any V-shaped rotor segment set, the magnetic pole of the separate rotor segment being twisted by an angle 2θ relative to the magnetic pole of the end rotor segment, in the same direction as the magnetic pole of the end rotor segment is twisted relative to the zero point angular position.

According to an embodiment of the present disclosure, the magnetic poles of any two adjacent rotor segments among the multiple rotor segments are twisted by an angle θ in opposite twisting directions relative to the zero point angular position.

According to an embodiment of the present disclosure, the rotor comprises a linear rotor segment set formed of multiple consecutive rotor segments, wherein the magnetic poles of all rotor segments in the linear rotor segment set form a linear slant, and the rotor comprises multiple discontinuous linear rotor segment sets arranged in parallel.

According to an embodiment of the present disclosure, the rotor comprises 6 rotor segments.

According to an embodiment of the present disclosure, maximum angles by which the magnetic poles of the multiple rotor segments of the rotor are twisted in different twisting directions relative to the zero point angular position are equal.

The present disclosure further relates to a motor comprising the rotor as described above.

The present disclosure further relates to an electric drive unit, which comprises the motor as described above.

The present disclosure further relates to a vehicle, comprising the electric drive unit as described above.

### BRIEF DESCRIPTION OF THE DRAWINGS

The foregoing and other features and advantages of the present disclosure will become more apparent from the following detailed description of exemplary embodiments with reference to the accompanying drawings, and the description and the accompanying drawings are for illustrative purposes only and are not intended to limit the scope of the present disclosure in any way. The drawings below are not drawn to scale according to actual dimensions but rather focus on showing the main purpose of the present disclosure.

FIG. 1A shows an exemplary arrangement of rotor segments of a rotor.

FIG. 1B is a simplified schematic drawing of FIG. 1A, showing V-shaped rotor segment groups.

FIG. 2A shows another exemplary arrangement of rotor segments of a rotor.

FIG. 2B is a simplified schematic drawing of FIG. 2A, showing V-shaped rotor segment groups.

FIG. 3A shows another exemplary arrangement of rotor segments of a rotor.

FIG. 3B is a simplified schematic drawing of FIG. 3A, showing V-shaped rotor segment groups.

FIG. 3C is another simplified schematic drawing of FIG. 3A, showing linear rotor segment groups.

In the drawings, identical or similar components are indicated by identical reference numerals.

### DETAILED DESCRIPTION

To clarify the objective, technical solutions and advantages of embodiments of the present disclosure, the technical solutions of the embodiments of the present disclosure are described clearly and completely below in conjunction with the drawings of the embodiments of the present disclosure. Obviously, the described embodiments are some rather than all of the embodiments of the present disclosure.

Unless defined otherwise, the technical or scientific terms used herein shall have the common meanings as understood by those of ordinary skill in the field to which the present disclosure belongs. Words such as “one”, “a” or “the” used in the description and the claims of the patent application disclosed herein do not indicate a quantity limit, but mean that there is at least one. Words such as “comprise” or “include” mean that the element or object appearing before the word encompasses the elements or objects and their equivalents listed after the word, without excluding other elements or objects. Words such as “first” and “second” used in the description and claims of the patent application disclosed herein do not denote any order, quantity or importance, and are merely used to distinguish different component parts. “Upper”, “lower”, “left”, “right”, etc. are merely used to indicate a relative positional relationship; when the absolute position of a described object changes, the relative positional relationship may also change accordingly. The terms “axial” and “axial direction” refer to the direction of extension of a centre axis X, the terms “radial” and “radial direction” refer to a direction perpendicular to the centre axis X, and the terms “circumferential” and “circumferential direction” refer to a circumferential direction around the centre axis X. A zero point angular position of the rotor is an angular position of a magnetic pole when the segments of the rotor have not been twisted, and corresponds to an initial angular position at which the rotor is located due to attraction by a stator magnetic field when a stator winding is energized with DC current.

Embodiments according to the present disclosure are described in detail with reference to the drawings. It must be noted here that in the drawings, identical reference numerals are assigned to component parts having substantially the same or similar structures and functions, and repeated descriptions of such component parts are omitted.

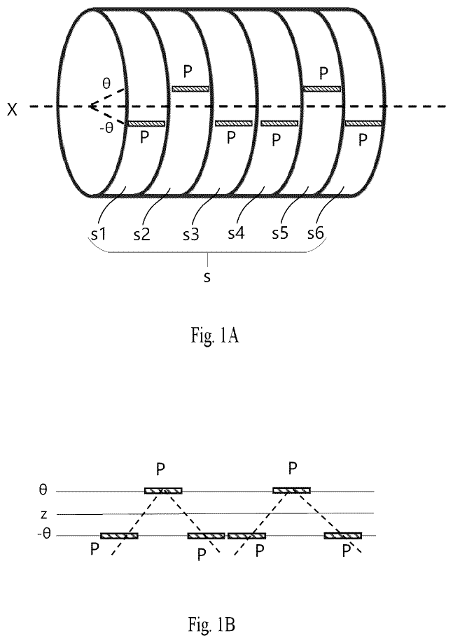

FIG. 1A shows a rotor 10 in a first embodiment of the present disclosure; FIG. 1B is a simplified schematic diagram of the rotor 10 shown in FIG. 1A.

As shown in FIG. 1A, the rotor 10 comprises 6 rotor segments s arranged side by side in the axial direction parallel to the centre axis X, specifically rotor segments s1-s6. It will be understood that the number of rotor segments comprised in the rotor 10 may be greater or less than 6. Each rotor segment s may comprise multiple rotor slots, in which are accommodated permanent magnets or other magnetic elements, forming one or more magnetic pole P arranged in the circumferential direction, preferably multiple magnetic poles P distributed uniformly in the circumferential direction. In FIG. 1A, one magnetic pole P is demonstratively shown relative to an initial angular position for each rotor segment s.

In the embodiment shown in FIGS. 1A and 1B, each rotor segment s is twisted relative to the initial angular position, to reduce the torque fluctuation produced by the motor tooth slot structure. As a result of this twisting, the magnetic pole P of each rotor segment is twisted by a certain angle relative to a zero point angular position z. FIG. 1B shows a simplified view of the twisting of the magnetic poles P relative to the zero point angular position z.

Specifically, as shown in FIGS. 1A and 1B, rotor segments s1, s2 and s3 form a V-shaped rotor segment set, specifically a first V-shaped rotor segment set. Rotor segment s2 is a middle rotor segment of the first V-shaped rotor segment set, and the magnetic pole P thereof is twisted by an angle θ in a twisting direction relative to the zero point angular position z; rotor segments s1 and s3 are two end rotor segments of the V-shaped rotor segment set, and magnetic poles P thereof are twisted by an angle θ in a twisting direction opposite to that of rotor segment s2 relative to the zero point angular position z.

Similarly, rotor segments s4, s5 and s6 also form a V-shaped rotor segment set, specifically a second V-shaped rotor segment set. In the second V-shaped rotor segment set, rotor segment s5 is a middle rotor segment, and the magnetic pole P thereof is twisted by an angle θ in the same twisting direction as the middle rotor segment s2 of the first V-shaped rotor segment set relative to the zero point angular position z; rotor segments s4 and s6 are two end rotor segments, and magnetic poles P thereof are twisted by an angle θ in a twisting direction opposite to that of rotor segment s5 relative to the zero point angular position z.

In the embodiment shown in FIGS. 1A and 1B, the 6 rotor segments of the rotor 10 form two V-shaped rotor segment sets, and the middle rotor segments of the two V-shaped rotor segment sets are twisted in the same twisting direction. That is, the course of the magnetic poles P of the rotor segments of the rotor 10 forms a structure of two V-shapes facing in the same direction. FIG. 1B shows the course of the magnetic poles P with dotted lines.

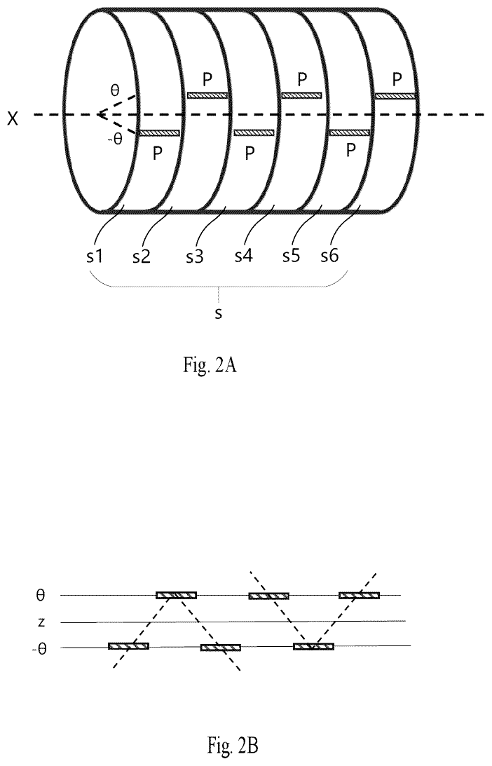

FIG. 2A shows a rotor 10 in a second embodiment of the present disclosure; FIG. 2B is a simplified schematic diagram of the rotor 10 shown in FIG. 2A. The following description of the second embodiment focuses on differences with respect to the first embodiment; a detailed description of shared features of the two embodiments is omitted.

Similarly to the first embodiment, the rotor 10 according to the second embodiment also comprises 6 rotor segments s, specifically rotor segments s1-s6, wherein rotor segments s1, s2 and s3 form a first V-shaped rotor segment set, and rotor segments s4, s5 and s6 form a second V-shaped rotor segment set. Unlike the first embodiment, the magnetic pole P of the middle rotor segment s2 of the first V-shaped rotor segment set and the magnetic pole P of the middle rotor segment s5 of the second V-shaped rotor segment set are twisted by an angle θ in opposite twisting directions relative to the zero point angular position. That is to say, in the second embodiment, the 6 rotor segments of the rotor 10 form two V-shaped rotor segment sets, and the middle rotor segments of the two V-shaped rotor segment sets are twisted in opposite twisting directions. That is, the course of the magnetic poles P of the rotor segments of the rotor 10 forms a structure of two V-shapes facing in opposite directions. FIG. 2B shows the course of the magnetic poles P with dotted lines.

In addition, in the second embodiment, when s1, s2 and s3 form a first V-shaped rotor segment set, rotor segments s2, s3 and s4 also form a V-shaped rotor segment set (a second V-shaped rotor segment set); specifically, rotor segment s3 is a middle rotor segment of the second V-shaped rotor segment set, rotor segments s2 and s4 are two end rotor segments of the second V-shaped rotor segment set, and the magnetic poles P of the middle rotor segment and each end rotor segment are twisted by an angle θ in opposite twisting directions relative to the zero point angular position z. The second V-shaped rotor segment set and the first V-shaped rotor segment set share two rotor segments, specifically s2 and s3, wherein the end rotor segment s3 of the first V-shaped rotor segment set forms the middle rotor segment of the second V-shaped rotor segment set. Similarly, rotor segments s3, s4 and s5 form a third V-shaped rotor segment set, and rotor segments s4, s5 and s6 form a fourth V-shaped rotor segment set. Among these V-shaped rotor segment sets, two adjacent V-shaped rotor segment sets have opposite directions.

In the second embodiment, when rotor segments s1, s2 and s3 form a first V-shaped rotor segment set, rotor segments s3, s4 and s5 also form a V-shaped rotor segment set (a second V-shaped rotor segment set); specifically, rotor segment s4 is a middle rotor segment of the second V-shaped rotor segment set, rotor segments s3 and s5 are two end rotor segments of the second V-shaped rotor segment set, and the magnetic poles P of the middle rotor segment and each end rotor segment are twisted by an angle θ in opposite twisting directions relative to the zero point angular position z. The second V-shaped rotor segment set and the first V-shaped rotor segment set share one end rotor segment, specifically s3. Similarly, rotor segments s4, s5 and s6 form a third V-shaped rotor segment set. The directions of these V-shaped rotor segment sets are all the same.

In addition, in the second embodiment, as shown in FIG. 2B, the magnetic poles P of rotor segments s1 and s2, s2 and s3, s3 and s4, s4 and s5, s5 and s6 of the rotor 10 are arranged alternately at two sides of the zero point angular position z, and twisted by an angle θ in opposite twisting directions. That is to say, the twisting of the rotor 10 may be configured to be twisting of the magnetic poles P of any two adjacent rotor segments by a twisting angle at two sides of the zero point angular position z respectively.

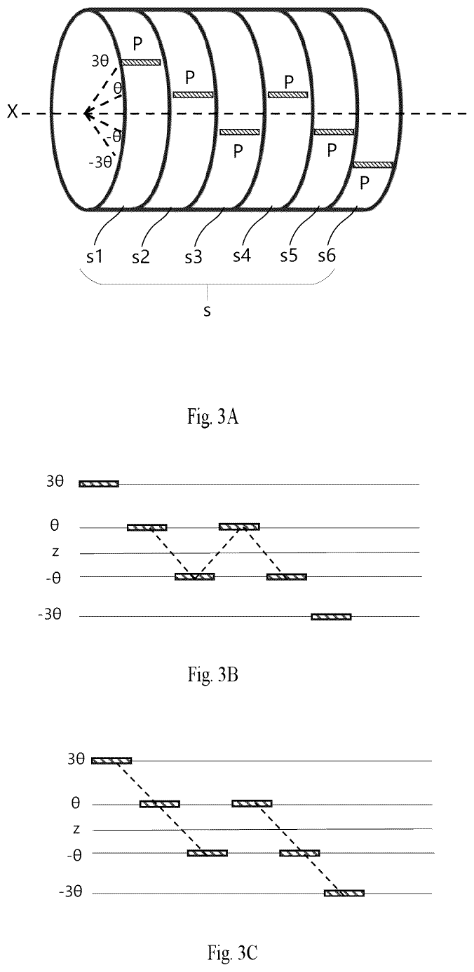

FIG. 3A shows a rotor 10 in a third embodiment of the present disclosure; FIGS. 3B and 3C are simplified schematic diagrams of the rotor 10 shown in FIG. 3A. The following description of the third embodiment focuses on differences with respect to the first and second embodiments; a detailed description of shared features is omitted.

The rotor 10 according to the third embodiment also comprises 6 rotor segments s, specifically rotor segments s1-s6, wherein rotor segments s2, s3 and s4 form a first V-shaped rotor segment set, and rotor segments s3, s4 and s5 form a second V-shaped rotor segment set. Unlike the first and second embodiments, rotor segments s1 and s6 do not belong to any V-shaped rotor segment set, and instead form separate rotor segments. The magnetic pole P of the separate rotor segment s1 is twisted by an angle 2θ relative to the magnetic pole P of the end rotor segment s2 of the first V-shaped rotor segment set, in the same direction as the magnetic pole P of the end rotor segment s2 is twisted relative to the zero point angular position z. The magnetic pole P of the separate rotor segment s6 is twisted by an angle 2θ relative to the magnetic pole P of the end rotor segment s5 of the second V-shaped rotor segment set, in the same direction as the magnetic pole P of the end rotor segment s5 is twisted relative to the zero point angular position z.

In addition, in the third embodiment, the 6 rotor segments s1-s6 of the rotor 10 may also be divided into sets in other ways. FIG. 3C shows a simplified schematic diagram of division into linear rotor segment sets.

As shown in the figure, the magnetic pole P of rotor segment s1 is twisted by an angle 3θ relative to the zero point angular position z, the magnetic pole P of rotor segment s2 is twisted by an angle θ relative to the zero point angular position z, and the magnetic pole P of rotor segment s3 is twisted by an angle −θ relative to the zero point angular position z. Thus, the magnetic poles P of rotor segments s1, s2 and s3 are linearly slanting, forming a first linear rotor segment set. Similarly, the magnetic pole P of rotor segment s4 is twisted by an angle θ relative to the zero point angular position z, the magnetic pole P of rotor segment s5 is twisted by an angle −θ relative to the zero point angular position z, and the magnetic pole P of rotor segment s6 is twisted by an angle −3θ relative to the zero point angular position z. Thus, the magnetic poles P of rotor segments s4, s5 and s6 are linearly slanting, forming a second linear rotor segment set. Compared with an existing linearly twisted rotor, the first linear rotor segment set and the second linear rotor segment set form two discontinuous linear segments arranged in parallel.

Three embodiments of rotor segment twisting methods for the rotor 10 according to the present disclosure have been described above with reference to the drawings. It has been found through simulation and experimental measurement that, compared with a motor that is twisted by an existing twisting method, the rotor according to the present disclosure is able to suppress motor torque fluctuation to a greater extent, reducing noise produced during motor operation, and improving vehicle NVH performance. In particular, noise associated with the tooth slot structure can be reduced by about 5 decibels.

It will also be noted that in the first and second embodiments, the maximum angle by which the magnetic poles P are twisted in positive and negative twisting directions relative to the zero point angular position z is θ in each case; in the third embodiment, the maximum angle by which the magnetic poles P are twisted in positive and negative twisting directions relative to the zero point angular position z is 3θ in each case. That is to say, the maximum angles by which the magnetic poles P of the rotor segments s of the rotor 10 are twisted in different twisting directions relative to the zero point angular position z are equal.

According to another aspect of the present disclosure, a motor is proposed, comprising the rotor as described above.

According to another aspect of the present disclosure, an electric drive unit is proposed, comprising the motor as described above.

According to another aspect of the present disclosure, a vehicle is proposed, comprising the electric drive unit as described above. The vehicle may be an electrified vehicle, such as a battery electric vehicle (BEV), a hybrid electric vehicle (HEV), a plug-in hybrid electric vehicle (PHEV), a range extended EV or a fuel cell electric vehicle (FCEV). The vehicle may also be a hydrogen-powered vehicle.

Certain features, structures or characteristics in one or more embodiments of the present disclosure may be combined appropriately.

The above is a description of the present disclosure and should not be regarded as a limitation thereof. Although exemplary embodiments of the present disclosure have been described, it will be readily appreciated by those skilled in the art that many modifications may be made to the exemplary embodiments without departing from the novel teaching and advantages of the present disclosure. Therefore, all such modifications are intended to be included in the scope of the present disclosure as defined by the claims. It should be understood that the above is a description of the present disclosure, and the present disclosure should not be considered to be limited to the specific embodiments disclosed; moreover, modifications to the disclosed embodiments and other embodiments are intended to be included within the scope of the present disclosure.

1. A rotor of a motor, wherein the rotor comprises multiple rotor segments arranged side by side in an axial direction parallel to a centre axis of the rotor and each of the rotor segments has one or more magnetic pole arranged in a circumferential direction around the centre axis,
wherein the rotor comprises one or more V-shaped rotor segment set, and the V-shaped rotor segment set is formed of three consecutive rotor segments, and the magnetic pole of a middle rotor segment of the V-shaped rotor segment set is twisted by an angle θ in a twisting direction relative to a zero point angular position of the rotor, and the magnetic poles of two end rotor segments of the V-shaped rotor segment set is twisted by an angle θ in a twisting direction opposite to that of the middle rotor segment relative to the zero point angular position.

2. The rotor according to claim 1, wherein
the rotor at least comprises a first V-shaped rotor segment set and a second V-shaped rotor segment set.

3. The rotor according to claim 2, wherein
the first V-shaped rotor segment set and the second V-shaped rotor segment set do not comprise a shared rotor segment.

4. The rotor according to claim 3, wherein
the magnetic poles of the middle rotor segments of the first V-shaped rotor segment set and the second V-shaped rotor segment set are twisted in the same twisting direction relative to the zero point angular position.

5. The rotor according to claim 3, wherein
the magnetic poles of the middle rotor segments of the first V-shaped rotor segment set and the second V-shaped rotor segment set are twisted in different twisting directions relative to the zero point angular position.

6. The rotor according to claim 2, wherein
the first V-shaped rotor segment set and the second V-shaped rotor segment set share two rotor segments, such that the middle rotor segment of the first V-shaped rotor segment set forms one end rotor segment of the second V-shaped rotor segment set, and one end rotor segment of the first V-shaped rotor segment set forms the middle rotor segment of the second V-shaped rotor segment set.

7. The rotor according to claim 2, wherein
the first V-shaped rotor segment set and the second V-shaped rotor segment set share one end rotor segment.

8. The rotor according to claim 1, wherein
the rotor further comprises a separate rotor segment which is adjacent to one end rotor segment of one V-shaped rotor segment set but does not belong to any V-shaped rotor segment set, and the magnetic pole of the separate rotor segment is twisted by an angle 2θ relative to the magnetic pole of the end rotor segment, in the same direction as the magnetic pole of the end rotor segment is twisted relative to the zero point angular position.

9. The rotor according to claim 1, wherein
the magnetic poles of any two adjacent rotor segments among the multiple rotor segments are twisted by an angle θ in opposite twisting directions relative to the zero point angular position.

10. The rotor according to claim 1, wherein
the motor rotor comprises a linear rotor segment set formed of multiple consecutive rotor segments, wherein the magnetic poles of all rotor segments in the linear rotor segment set form a linear slant, and
the motor rotor comprises multiple discontinuous linear rotor segment sets arranged in parallel.

11. The rotor according to claim 1, wherein
the motor rotor comprises 6 rotor segments.

12. The rotor according to claim 1, wherein
maximum angles by which the magnetic poles of the multiple rotor segments of the motor rotor are twisted in different twisting directions relative to the zero point angular position are equal.

13. A motor, wherein the motor comprises the rotor according to claim 1.

14. An electric drive unit, wherein the electric drive unit at least comprises the motor according to claim 13.

15. A vehicle, wherein the vehicle comprises the electric drive unit according to claim 14.

16. The rotor according to claim 2, wherein
the rotor further comprises a separate rotor segment which is adjacent to one end rotor segment of one V-shaped rotor segment set but does not belong to any V-shaped rotor segment set, and the magnetic pole of the separate rotor segment is twisted by an angle 2θ relative to the magnetic pole of the end rotor segment, in the same direction as the magnetic pole of the end rotor segment is twisted relative to the zero point angular position.

17. The rotor according to claim 2, wherein
the magnetic poles of any two adjacent rotor segments among the multiple rotor segments are twisted by an angle θ in opposite twisting directions relative to the zero point angular position.

18. The rotor according to claim 2, wherein
the motor rotor comprises 6 rotor segments.

19. The rotor according to claim 2, wherein
maximum angles by which the magnetic poles of the multiple rotor segments of the motor rotor are twisted in different twisting directions relative to the zero point angular position are equal.

20. A motor, wherein the motor comprises the rotor according to claim 2.
